(19) United States
(12) Patent Application Publication
(10) Pub. No.: US 2009/0061957 A1
(43) Pub. Date: Mar. 5, 2009

(54) SOLAR OPERATED BATTERY HEADSET

(76) Inventor: Barry B. Bauman, Kitchener (CA)

Correspondence Address: DARYL W SCHNURR;MILLER THOMSON LLP, ACCELERATOR BUILDING, 295 HAGEY BLVD., SUITE 300, WATERLOO, ON, N2L 6R5, CA

(21) Appl. No.: 11/848,130

(22) Filed: Aug. 30, 2007

(51) Int. Cl. H04M 1/00

(52) U.S. Cl. 455/575.2

(57) ABSTRACT

A wireless headset (eg. Bluetooth, a trade mark) is powered by one or more rechargeable batteries and has a solar panel mounted thereon connected to the battery to augment or replace the battery power. The solar panel is preferably used in conjunction with a battery in the headset and significantly increases the battery life. With the solar panel, the headset can be used for much longer periods of time without recharging.

### BACKGROUND OF THE INVENTION

1. Field of the Invention

This invention relates to a solar powered wireless headset having a solar panel mounted on the headset and connected to power wires for the headset.

2. Description of the Prior Art

Wireless headsets are known, and in particular, the Bluetooth (a trade mark) wireless headset is mounted on an ear of a user and can be used to receive or transmit wireless communications. The Bluetooth wireless headsets are powered by rechargeable batteries. One of the disadvantages of the Bluetooth headsets is that the batteries must be recharged frequently, usually on a daily basis, causing down time for the headset or the user must have a spare set of rechargeable batteries that have already been charged and can be used to replace the batteries in the headset that require charging. Otherwise, the wireless headset cannot be used when the batteries are being recharged.

In headsets where the rechargeable batteries are permanently mounted inside, charging of these batteries does not commence until the headset is turned off, making the Bluetooth wireless device unusable during recharging.

Also, when the batteries have been recharged, the wireless headset must be restarted and the procedure for restarting is time-consuming. The recharging process can also be highly inconvenient and time-consuming for users.

The Bluetooth wireless headsets operate on a rechargeable battery within a range of 1.5 to 2.6 volts DC.

### SUMMARY OF THE INVENTION

It is an object of the present invention to provide a wireless headset that can be powered exclusively by a solar panel, but preferably has a combination of battery power and solar power, the solar power recharging the battery whenever energy consumed by the headset is less than energy produced by solar power.

It is a further object of the present invention to provide a wireless headset that has a solar panel thereon of substantially the same footprint as the headset.

It is still a further object of the present invention to provide a solar panel and wireless headset in combination where the solar panel is connected into the same wires that are connected to a battery for the headset. Preferably, the battery is rechargeable.

A solar powered wireless headset comprises a headset for mounting on one ear of a user, the headset having power wires extending to a rechargeable battery. A solar panel is mounted on or adjacent to a surface of said headset, the solar panel being connected in parallel with the battery to power the headset and/or recharge the battery.

A solar powered wireless headset comprises a headset for mounting on an ear of a user, the headset having a receiver and transmitter contained within a housing and being powered by a solar panel mounted on the housing. An output from the solar panel being connected to a rechargeable battery located within the housing.

A solar powered wireless headset comprises a headset for mounting on one ear of a user, the headset having power wires extending to an energy supply. A solar panel is mounted on or adjacent to a surface of the headset, the solar panel being connected to the power wires to power the headset and to replenish the energy supply when sufficient energy is received from said solar panel. The energy supply is connected to power the headset when the solar panel is not producing sufficient energy.

### BRIEF DESCRIPTION OF THE DRAWINGS

FIG. 1 is a perspective view of a Bluetooth wireless headset having a solar panel mounted thereon and connected to power the headset;

FIG. 2 is a perspective view of the solar panel and wireless headset shown in FIG. 1 from a different angle;

FIG. 3 is a block diagram of the electrical connections.

### DETAILED DESCRIPTION OF A PREFERRED EMBODIMENT

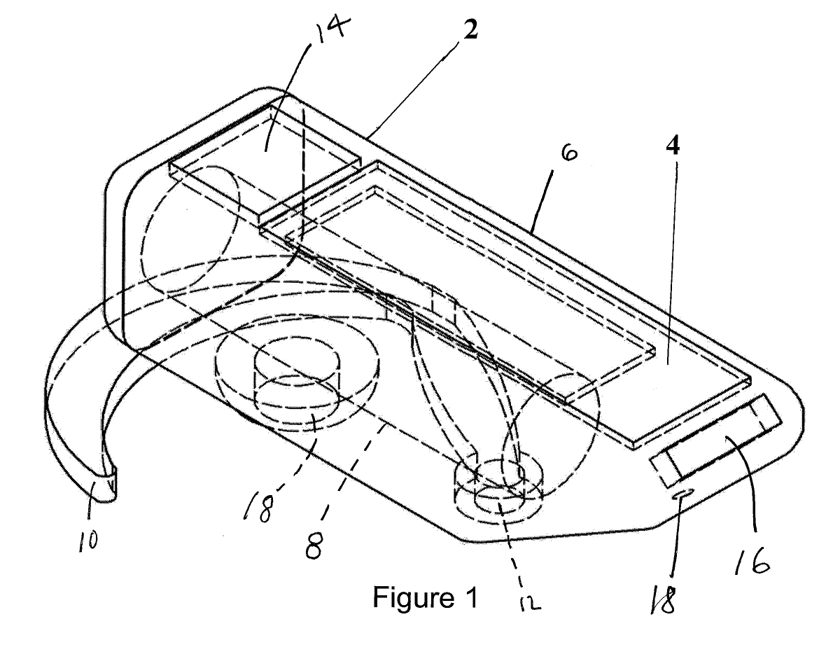

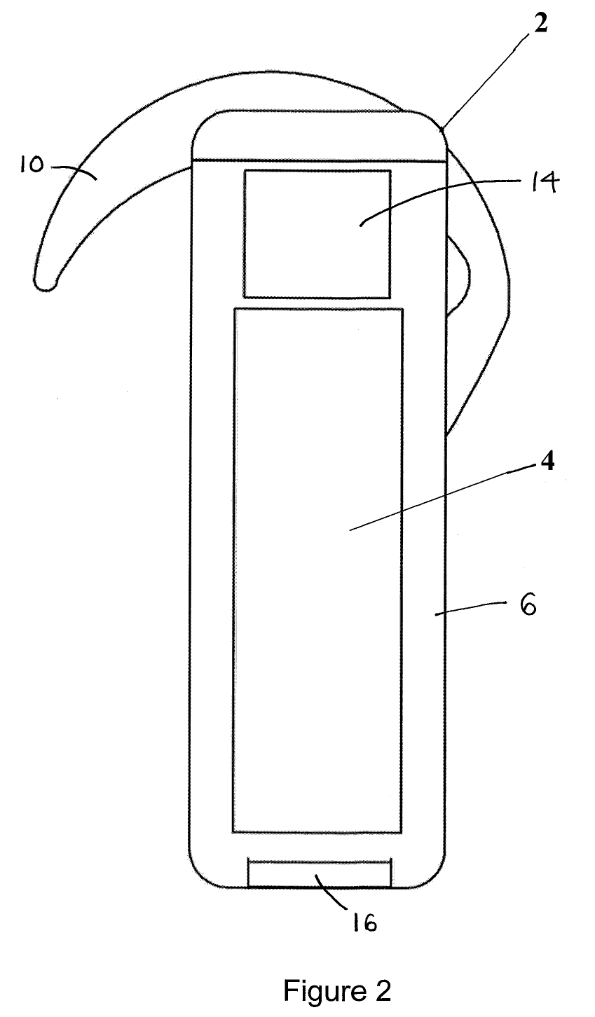

In FIGS. 1 and 2, it can be seen that a wireless headset 2 has a solar panel 4 mounted thereon. The headset is preferably operated by Bluetooth software. The solar panel 4 can be mounted on, or adjacent to an outer surface of the headset, or can be part of the outer casing 6 of the headset 2 and is connected by wires into the headset to provide electrical power for the headset. The headset 2 has a rechargeable battery or batteries 8 (henceforth battery) and the solar panel is connected the headset in parallel to the battery. The headset 2 has an earmount 10 for mounting the headset on an ear (not shown) of a user (not shown). The earmount 10 is pivotally mounted on the casing 6 at a pivot axis 12.

The headset 2 has an operational selector 14 at one end of the casing 6 and a power indicator light 16 at an opposite end. The operational selector has an on/off mode and a rest/activate mode or sleep mode. The power indicator light 16 is preferably an LED. A microphone 18 is located within the casing 6 adjacent to the light 16 and a speaker 18 is located to be aligned with the ear of a user (not shown).

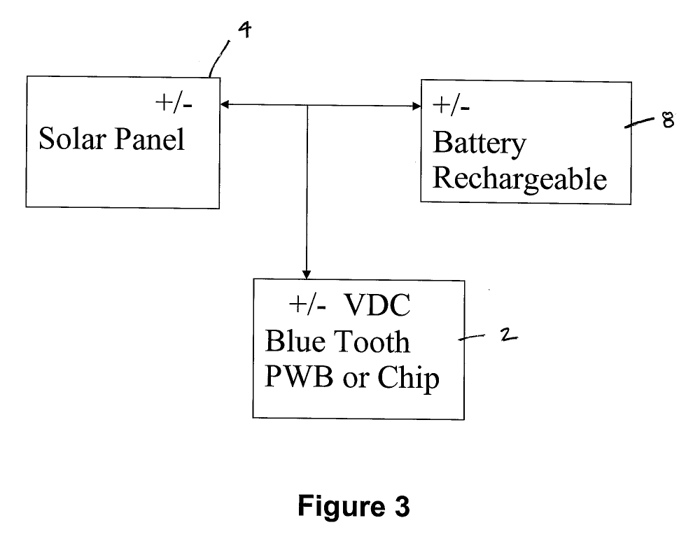

In FIG. 3, the headset 2 is powered by the rechargeable battery 8 and the solar panel 4 is connected in parallel to the headset with the battery or batteries. The solar panel is connected to the same wires (not shown) that the battery is connected to. The solar panel is connected in parallel with the batteries so that when the headset is operating, the headset can draw power from either or both of the battery and solar panel. Any excess power from the solar panel beyond that required to power the headset can be used to recharge the battery. In the sleep mode, virtually all of the power from the solar panel is used to recharge the battery. The sleep mode is a rest mode. When the headset is turned off, all of the power generated by the solar panel is used to recharge the battery.

The solar panel is of a sufficient size that it has a significantly larger voltage output than the voltage of the battery powering the headset. For example, it has been found that when a 1.5 volt battery is used in the headset, a 2.8 volt solar panel provides adequate power to the headset sufficient to recharge the battery during normal usage for a long period of time. Preferably, the voltage output of the solar panel is approximately double the voltage output of the battery. Also, the headset has a sleep mode and the solar panel is sufficient to recharge the battery, despite changing light intensity conditions, when the headset is left in sleep mode so that it is no longer necessary to turn off the headset. The headset can be reactivated from sleep mode much more quickly than it can be reactivated from the off mode. With the present invention, the solar panel will recharge the battery sufficiently when the headset is in the sleep mode to make it unnecessary to turn the headset off at any time.

Preferably, the headset has a receiver and a transmitter. The receiver and transmitter are conventional and are not shown in the drawings.

The solar panel can form a wall of the headset and preferably, an electronic circuit of the headset is formed on an inner surface of the solar panel.

When a headset does not have a solar panel connected thereto, the battery must be recharged on a daily basis. When a solar panel is used with the headset along with a rechargeable battery, the battery does not require recharging for long periods of time. For example, a wireless headset having a 2.8 volt solar panel and a 1.5 volt rechargeable battery can be used for greater than six months without recharging and by using the sleep mode, without turning the headset off during that period. The solar panel significantly extends the battery life and will generate power from indoor lighting as well as outdoor light.

The solar panel changes the way the headset is used. Without the solar panel, the headset battery must be recharged on a daily basis. The recharging process is both time consuming and annoying. Also, during the recharging the headset is turned off and must be turned on again when recharging has been completed. With the solar panel the battery is recharged automatically when the headset is on or off and no specific recharge is required for a long period of time. The actual time between specific recharges is unknown, but time periods of longer than one month and even longer than six months have occurred. The presence of the solar panel results in the wireless headset being much more convenient to use.

1. A solar powered wireless headset comprising a headset for mounting on one ear of a user, said headset having power wires extending to a rechargeable battery, a solar panel being mounted on or adjacent to a surface of said headset, said solar panel being connected in parallel with said battery to power said headset and/or recharge said battery.

2. A headset as claimed in claim 1 wherein said headset is a headset operated by bluetooth software and has an on/off mode and a rest/activate mode.

3. A headset as claimed in claim 1 wherein said headset is connected to be powered by said battery, said solar panel or a combination of both, said polar panel being connected to recharge said battery whenever energy produced by said solar panel exceeds energy required by said headset.

4. A headset as claimed in claim 3 wherein said solar panel is sized to have a significantly larger voltage than said battery.

5. A headset as claimed in claim 4 wherein a voltage of said solar panel is approximately double a voltage of said battery.

6. A solar powered wireless headset comprising a headset mounted on an ear of a user, said headset having a receiver and transmitter contained within a housing and being powered by a solar panel mounted on said housing, an output from said solar panel being connected to a rechargeable battery located within said housing.

7. A solar powered wireless headset comprising a headset for mounting on one ear of a user, said headset having power wires extending to an energy supply, a solar panel being mounted on or adjacent to a surface of said headset, said solar panel being connected to said power wires to power said headset and to replenish said energy supply when sufficient energy is received from said solar panel, said energy supply being connected to power said headset when said solar panel is not producing sufficient energy.

8. A headset as claimed in claim 7 wherein said solar panel forms a wall of said headset.

9. A headset as claimed in claim 8 wherein an electronic circuit of said headset is formed on an inner surface of said solar panel.
